(19) United States
(12) Patent Application Publication
(10) Pub. No.: US 2012/0060117 A1
(43) Pub. Date: Mar. 8, 2012

(54) USER INTERFACE PROVIDING METHOD AND APPARATUS

(75) Inventors: Il Geun BOK, Seoul (KR); Ji Young KANG, Gyeonggi-do (KR); Hyun Kyoung KIM, Seoul (KR)

(73) Assignee: SAMSUNG ELECTRONICS CO., LTD., Gyeonggi-Do (KR)

(21) Appl. No.: 13/186,620

(22) Filed: Jul. 20, 2011

(30) Foreign Application Priority Data
Sep. 3, 2010 (KR) 10-2010-0086501

(51) Int. Cl. G06F 3/048

(52) U.S. Cl. 715/810

(57) ABSTRACT

A method and apparatus for providing a user interface are disclosed. The apparatus provides a visible area composed of a first touch region to receive a touch gesture for shifting list items and a second touch region to receive a touch gesture for changing selection status of each item.

### CLAIM OF PRIORITY

This application claims the benefit under 35 U.S.C. §119 of a Korean Patent Application filed in the Korean Intellectual Property Office on Sep. 3, 2010 and assigned Serial No. 10-2010-0086501, the entire disclosure of which is hereby incorporated by reference.

### BACKGROUND OF THE INVENTION

1. Field of the Invention

The present invention relates to a user interface and, more particularly, to a touch-based user interface.

2. Description of the Related Art

A user interface may include physical or virtual media where a user can interact with an object, system, device or program. A user interface may have an input means enabling the user to enter an input to the system, and an output means generating a response or result corresponding to the input.

An input device is needed to generate an input to the system corresponding to the user manipulation for, for example, moving the cursor or selecting an object on the touchscreen. A button, key, mouse, trackball, touch pad, joystick, and touchscreen are examples of an input device. An output device is needed to provide the user with system responses in a visual, auditory or haptic form. A display unit, touchscreen, speaker and vibrator are examples of the output device.

A touchscreen is both an input and output device. The user may touch the touchscreen with a finger or stylus. A touch gesture occurred on the touchscreen is recognized and analyzed to perform a corresponding operation.

### SUMMARY OF THE INVENTION

The present invention provides a method and apparatus of improving a user interface by providing a more efficient touch-based user interface scheme.

In accordance with an exemplary embodiment of the present invention, a method for providing a user interface includes: providing a visible area comprising a first touch region for displaying list items and a second touch region for indicating the selection status of each item; detecting the occurrence of a touch gesture in the visible area; determining whether the touch gesture has occurred in the first touch region or in the second touch region; and shifting, when the touch gesture has occurred in the first touch region, the items in the visible area, and changing the selection status of an item when the touch gesture has occurred in the second touch region

In accordance with another exemplary embodiment of the present invention, an apparatus for providing a user interface includes: a display handler providing a visible area composed of a first touch region for displaying list items and a comprising a touch region for indicating the selection status of each item; a touch recognizer detecting the occurrence of a touch gesture in the visible area; and a control unit determining whether the touch gesture has occurred in the first touch region or in the second touch region, and shifting, when the touch gesture has occurred in the first touch region, the items in the visible area, and changing the selection status of an item when the touch gesture has occurred in the second touch region.

In the embodiment, changing the selection status of an item comprises displaying selection status of each item covering from a touch start point to a touch end point of the touch gesture as marked. In alternate embodiment, changing selection status of an item comprises displaying selection status of each item covering from a touch start point to a touch end point of the touch gesture, except an item previously checked, as marked.

In the present invention, a user interface providing method and apparatus are provided. Touch gestures of the same type made to different parts of a single item may trigger different operations. Hence, it is possible to more effectively accept user input.

### BRIEF DESCRIPTION OF THE DRAWINGS

The features and advantages of the present invention will be more apparent from the following detailed description in conjunction with the accompanying drawings, in which:

FIG. 1 is a block diagram of a user interface providing apparatus according to an exemplary embodiment of the present invention;

FIG. 2 is a screen representation describing a visible area;

FIG. 3 is another screen representation describing the visible area;

FIG. 4 is screen representations for handling a touch gesture occurring in a first touch region of the visible area;

FIG. 5 is screen representations for handling a touch gesture occurring in a second touch region of the visible area;

FIG. 6 is screen representations for handling a touch gesture occurring in the first touch region;

FIG. 7 is screen representations for handling a touch gesture occurring in the second touch region;

FIG. 8 is screen representations for handling a touch gesture occurring in the second touch region;

FIG. 9 is another screen representation describing the visible area;

FIG. 10 is a flowchart of a user interface providing method according to another exemplary embodiment of the present invention; and

FIG. 11 is a flowchart of a user interface providing method according to another exemplary embodiment of the present invention.

### DETAILED DESCRIPTION OF THE INVENTION

Hereinafter, exemplary embodiments of the present invention are described in detail with reference to the accompanying drawings.

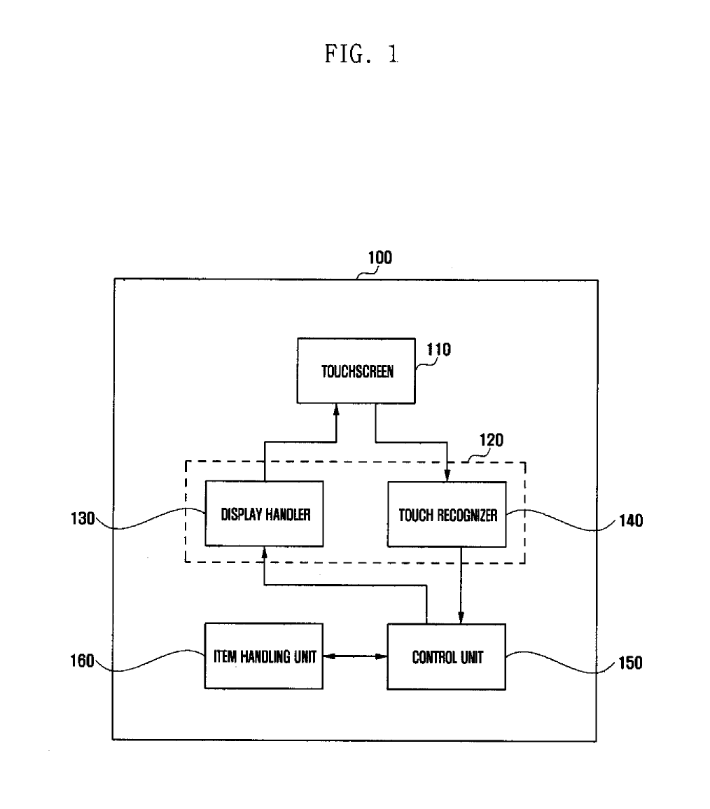

FIG. 1 is a block diagram of a user interface providing apparatus 100 according to an exemplary embodiment of the present invention.

The user interface providing apparatus 100 may be any electronic device such as a television, computer, cellular phone, smart phone, kiosk, printer, scanner, e-book reader or multimedia player. The user interface providing apparatus 100 may also be a device having a touchscreen or a touchscreen control device that is connectable to a computer or a communication device.

Referring to FIG. 1, the user interface providing apparatus 100 includes a touchscreen handling unit 120 and a control unit 150. The touchscreen handling unit 120 may include a display handler 130 and a touch recognizer 140. The user interface providing apparatus 100 may further include an item handling unit 160.

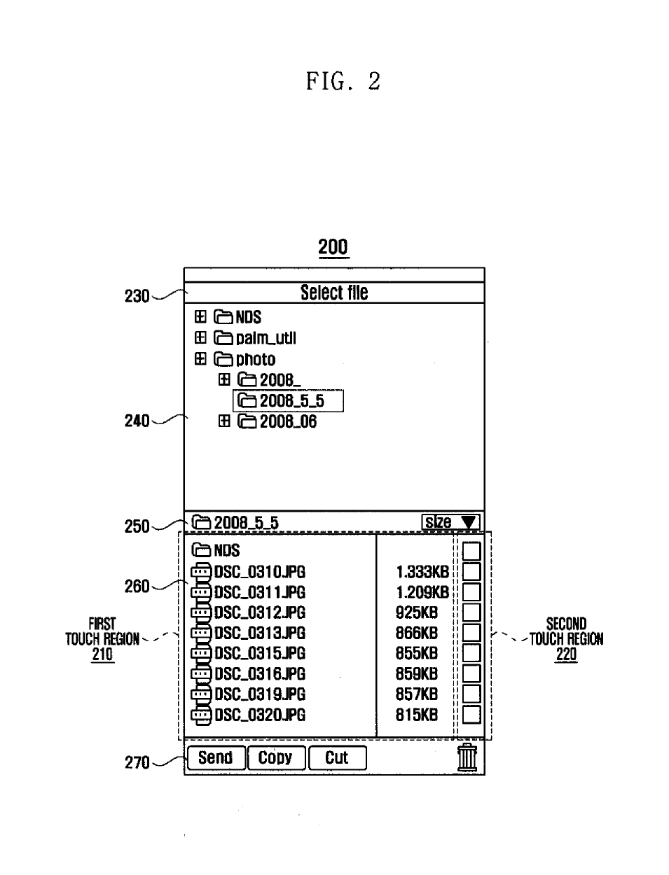

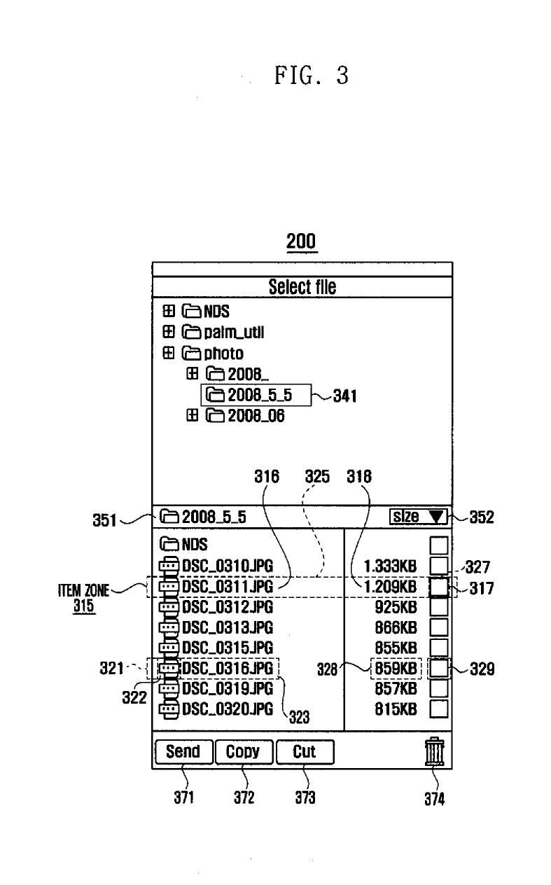

Next, the components of the apparatus 100 will be described in detail with reference to FIGS. 2 and 3.

The display handler 130 may provide a visible area 200 on the touchscreen 110. The visible area 200 may include a first touch region 210 for entering touch input to display a list of items, and a second touch region 220 for entering touch input to set the selection status of each item. The display handler 130 may be implemented using a software or hardware module capable of processing image signals. The display handler 130 may receive an image signal or image control signal from the control unit 150, and processes the received signal so as to display a graphical user interface on the touchscreen 110.

For example, the display handler 130 may supply an image signal carrying a list of items to the touchscreen 110. When a control signal for scrolling items is received from the control unit 150, the display handler 130 may supply an image signal to the touchscreen 110 so as to shift items on the visible area 200. When a control signal for displaying the selection status of each item is received from the control unit 150, the display handler 130 may supply an image signal to the touchscreen 110 so as to set a preset pattern at a portion of each item zone. The pattern may include a color, a brightness level, a radio button or a check box 317 to indicate selection/non-selection of each item.

The touch recognizer 140 may receive a touch input signal from the touchscreen 110 and recognize a corresponding touch gesture in the visible area 200. A touch input signal may carry information regarding coordinates of a touch point on the visible area 200 or a path from a touch start point to the touch end point. The touch recognizer 140 may obtain information on the speed, contact duration, or direction of a touch gesture using a touch input signal. The touch recognizer 140 may send touch information containing data on at least one of a touch point, path, speed, contact duration, and direction of a touch gesture to the control unit 150. The touch recognizer 140 may be realized using a software or hardware module capable of processing touch input signals.

In another embodiment, the touchscreen handling unit 120 may be implemented as a single software or hardware module combining the display handler 130 and the touch recognizer 140.

The control unit 150 may receive touch information from the touch recognizer 140 and determine whether a corresponding touch gesture has occurred in the first touch region 210 or the second touch region 220 of the visible area 200. On the basis of the touch information, the control unit 150 may determine the type of a touch gesture such as tap, flick, drag or swipe.

The control unit 150 may shift a list of items in response to a touch gesture occurring in the first touch region 210, and may change the selection status of at least one item in response to a touch gesture occurring in the second touch region 220.

When a touch gesture has occurred in the first touch region 210, the control unit 150 may control an operation to shift a list of items in a preset direction on the visible area 200 on the basis of at least one of the speed, number of touches, and contact duration of the touch gesture. In shifting, some items of the list disappear from the visible area 200, some items are introduced in the visible area 200, and new items appear thereon in a continuous fashion. The control unit 150 may send a control signal to the display handler 130 so as to shift a list of items.

When a touch gesture has occurred in the second touch region 220, the control unit 150 may change the selection status of at least one item corresponding to the path from the touch start point to the touch end point. In response to a touch gesture occurring in the second touch region 220, the control unit 150 may identify at least one item related to the touch gesture, and control an operation to display the selection status of the identified item at a portion of the corresponding item zone. The control unit 150 may send a control signal to the display handler 130 so as to display the selection status of each item. For example, the control unit 150 may control the display handler 130 to display the selection status of each item at a portion of the first touch region 210 (or the second touch region 220). That is, the control unit 150 may cause the mark in the radio button or check box 317 to be toggled corresponding to the identified item. In another embodiment, the control unit 150 may control the display handler 130 to change at least one of the color and brightness corresponding to the identified item on the first touch region 210 (or the second touch region 220). The control unit 150 may send information regarding selected items among identified items to the item handling unit 160. For example, in response to reception of a command signal related to a command such as “Send” 371, “Copy” 372 or “Cut” 373 (for cut and paste), the control unit 150 may send information regarding selected items to the item handling unit 160.

The item handling unit 160 may receive information on a selected item from the control unit 150 and perform an operation on a file associated with the selected item according to a received command signal. For example, when the command signal is related to “Delete” 374 or “Copy” 372, the item handling unit 160 may delete or copy the file associated with the selected item. The item handling unit 160 may send an indication for results of processing the selected item to the control unit 150, which then controls an operation to display updated selection status or an updated list of items according to the result indication.

The touchscreen 110 may receive an image signal from the display handler 130. The image signal may carry data for the visible area 200, data for displaying items, data for shifting items, and data for item selection status. The touchscreen 110 may send a touch input signal to the touch recognizer 140. A touch input signal may carry information regarding coordinates of a touch point on the visible area 200 or a path from a touch start point to the touch end point. The touchscreen 110 may include a screen display module and a touch sensor. The screen display module may be realized using technology based on liquid crystal display (LCD), plasma display panel (PDP), light emitting diodes (LED), light emitting polymer display (LDP), or organic light emitting diodes (OLED). The touch sensor may be placed at the front or rear of the screen display module or at the screen. The touch sensor may be realized using capacitive, resistive, infrared or surface acoustic wave technology.

The visible area 200 may include a list region 260 for a list of items. The list region 260 may include the first touch region 210 to receive a touch input for shifting items and the second touch region 220 to receive a touch input for changing the selection status of items. A list of items may be displayed in the first touch region 210, and the selection status of items may be displayed in the second touch region 220.

The list region 260 may be composed of one or more item zones 315. Each item zone 315 may be divided into a first partial zone 325 overlapping with the first touch region 210 and a second partial zone 327 overlapping with the second touch region 220. That is, the first touch region 210 may be composed of one or more first partial zones 325 and the second touch region 220 may be composed of one or more second partial zones 327.

For an item, the sizes of the first partial zone 325 and the second partial zone 327 may be adjusted according to item information. Information of a single item may include at least one of icon 322, name 323, size 328, modification date, file type and selection status 329.

For example, first partial information 321 of an item may include the icon 322 and name 323, and second partial information 329 of the item may include the selection status (i.e., check box 329). On the visible area 200, the first partial information 321 may be assigned to the first partial zone 325 constituting the first touch region 210, and the second partial information 329 may be assigned to the second partial zone 327 constituting the second touch region 220. The size of the first touch region 210 may be varied according to the size of the first partial information 321. Similarly, the size of the second touch region 220 may be varied according to the size of the second partial information 329. For example, when the first partial information 321 of an item includes a name 323, the type of the first touch region 210 may be determined according to the number of characters to be displayed.

By separating the first partial information 321 and the second partial information 329 for each item, the control unit 150 may readily determine whether a touch gesture has occurred in the first touch region 210 or in the second touch region 220 on the visible area 200. Alternatively, when a touch gesture occurs, the control unit 150 may identify the item to which the touch gesture applies, divide the item zone 315 into the first partial information and the second partial information, and determine whether the touch gesture has occurred in the first touch region 210 or in the second touch region 220.

For example, the touch recognizer 140 may receive a touch input signal from the touchscreen 110 and identify the type of the touch gesture. The control unit 150 may determine the item corresponding to the touch gesture and identify which of the first partial information 321 and the second partial information 329 of the item has been touched. When the first partial information 321 of the item has been touched, the control unit 150 may perform a first function; and when the second partial information 329 of the item has been touched, the control unit 150 may perform a second function. Here, for each item, the first partial information 321 and the second partial information 329 may be arranged so as not to overlap each other. For the identified item, the first partial information 321 and the second partial information 329 may include at least one of icon 322, name 323, size 328, modification date, file type and selection status 329. The first function may include shifting items on the screen, and the second function may include changing the selection status of the item. The first function and second function may also be set to other functions, and hence the control unit 150 may perform different operations.

The item zone 315 corresponds to a single item, and may include at least one of an icon and name 316. The item associated with an item zone 315 may be a file or folder. The item zone 315 may further include a selection status indication for the item. The selection status may be indicated by a radio button or check box 317. The selection status does not appear when the corresponding item is not selected. When the corresponding item is selected, the selection status may be indicated by one of various marks such as ‘□’, ‘x’ and ‘o’ in a radio button or check box 317. Alternatively, the selection status may be indicated by changing the color or the brightness of some portion of the item zone 315.

The item zone 315 may further include the size 318 of the item. When the listing criterion 352 is set to “size” in advance or by user selection, the size 318 may be included in the item zone 315. The listing criterion 352 may be set to “modification date”, “file type” or the like.

The visible area 200 may further include a list information region 250 providing information on the item list. The list information region 250 may contain the listing criterion 352. The list information region 250 may further contain a folder name 351 of the folder containing items or location information of an item list.

The visible area 200 may further include a folder region 240 in which the hierarchical structure of the folder 341 containing items is displayed. The folder region 240 may appear in the visible area 200 in response to reception of an “Attach” command or “Search” command. The folder region 240 may be displayed so as not to overlap with the first touch region 210 and the second touch region 220. In the embodiment, the user interface providing apparatus 100 may provide a preview image of a selected item through the folder region 240 instead of a folder structure. The user interface providing apparatus 100 may provide thumbnail images of items contained in the folder 341 through the folder region 240.

The visible area 200 may further include a title region 230 in which guide information or an application name may be displayed. For example, “Select file” may be displayed in the title region 230.

The visible area 200 may further include a menu region 270 to enable the user to specify an item handling option or to display a preset item handling option. For example, the menu region 270 may indicate at least one of “Send” 371, “Copy” 372, “Cut-and-paste” 373 and “Delete” 374 as item handling options. When one handling option is selected, a command signal may be generated so that an operation specified by the handling option is applied to the file associated with a selected item. In the present invention, touch gestures of the same type occurring at the first touch region 210 and the second touch region 220 may cause invocation of different functions. For a single item, touch gestures of the same type occurring at the first partial zone 325 (or the first partial information 321) and the second partial zone 327 (or the second partial information 329) may cause invocation of different functions.

Next, a description is given of functions invoked by touch gestures occurring at the touch regions. Here, the touch gestures may be a single or double tap.

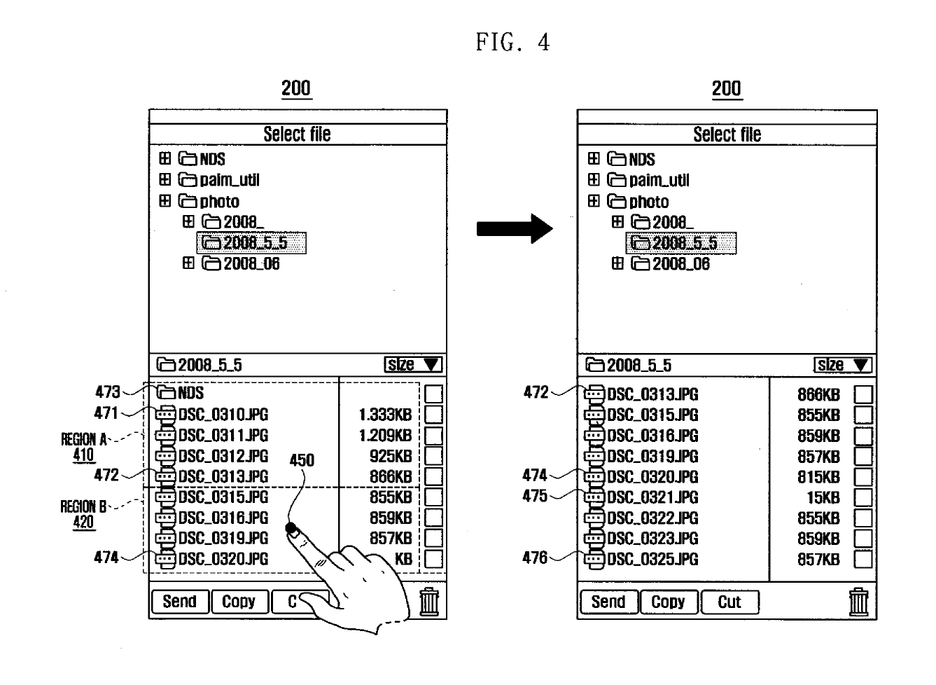

FIG. 4 is screen representations for handling a touch gesture occurring in the first touch region of the visible area.

When a touch gesture occurs at the first touch region 210, list items may be shifted (or scrolled). Using at least one of the contact duration or the number of touches of a touch gesture 450, the control unit 150 may shift items in a preset direction so that some items are caused to disappear from the visible area 200, some items are moved in the visible area 200, and new items are caused to appear thereon in a continuous fashion. In another embodiment, when the touch gesture corresponds to a tap, item shifting may be performed in a preset direction.

The first touch region 210 may be divided into a region A 410 and a region B 420 according to the item shifting direction for a touch gesture 450. For example, when a touch gesture 450 occurs at the region A 410, items may be shifted downwards; and when a touch gesture 450 occurs at the region B 420, items may be shifted upwards. As shown, before the occurrence of a touch gesture, items 473 to 474 are displayed in the visible area 200. When a touch gesture 450 occurs at the region B 420, four upper items including item 473 and item 471 have disappeared, item 472 is displayed at the beginning of the list region 260, and new items 475 to 476 are displayed.

Alternatively, as item 473 is associated with a folder, item shifting may be performed so that item 473 remains as before and items 471 to 472 are caused to disappear. The amount of shifting may be preset by the user interface providing apparatus 100 or be set according to user selection. The amount of shifting may also be determined according to the contact duration of a touch gesture 450. For example, when the contact duration is less than or equal to 0.2 seconds, the control unit 150 may shift list items by one item. When the contact duration is greater than 0.2 seconds and less than 1 second, the control unit 150 may shift list items by one item per 0.2 seconds. When the contact duration is greater than or equal to 1 second, the control unit 150 may rotate list items at a preset cycle until the contact is ended.

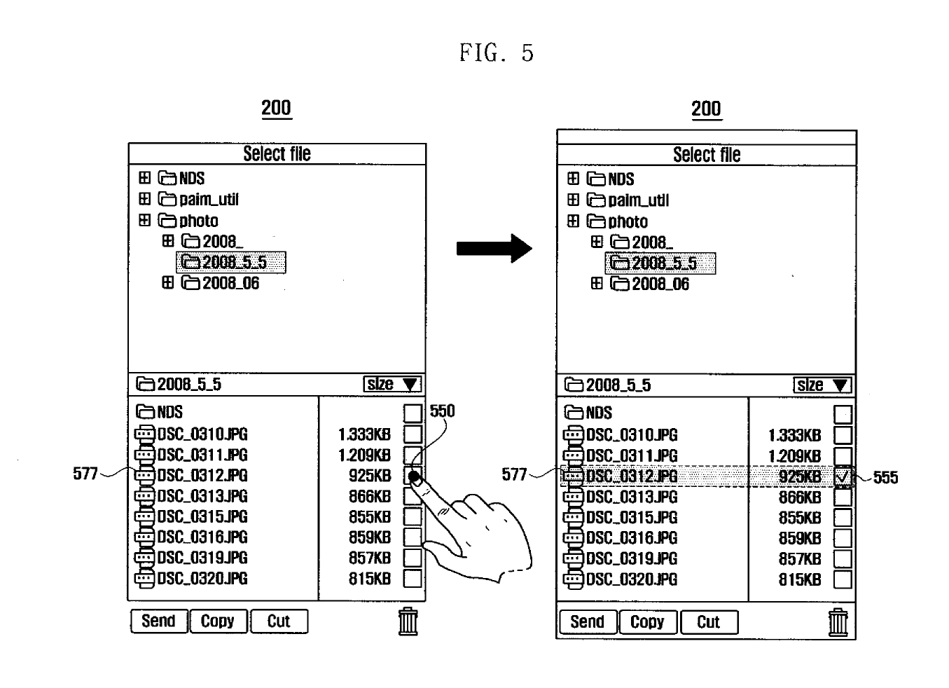

FIG. 5 is screen representations for handling a touch gesture occurring in the second touch region of the visible area.

When a touch gesture 550 occurs at the second touch region 220, the selection status of one or more items on the path from the touch start point to the touch end point may be changed. That is, when a touch gesture 550 occurs in the second touch region 220, the control unit 150 may identify one or more items corresponding to the touch gesture 550. For example, the control unit 150 may identify item 577 by checking the item zone corresponding to the touch gesture 550, and change the selection status of item 577. The selection status of item 577 is toggled. That is, when item 577 has not been selected before occurrence of the touch gesture 550, a selection mark 555 may be indicated in the check box of the item zone of item 577 after occurrence of the touch gesture 550. When item 577 has been selected before occurrence of the touch gesture 550, a selection mark 555 in the check box of the item zone of item 577 may disappear after occurrence of the touch gesture 550. Additionally, in response to the touch gesture 550, at least one of the color or brightness of a portion of the item zone associated with item 577 may be changed.

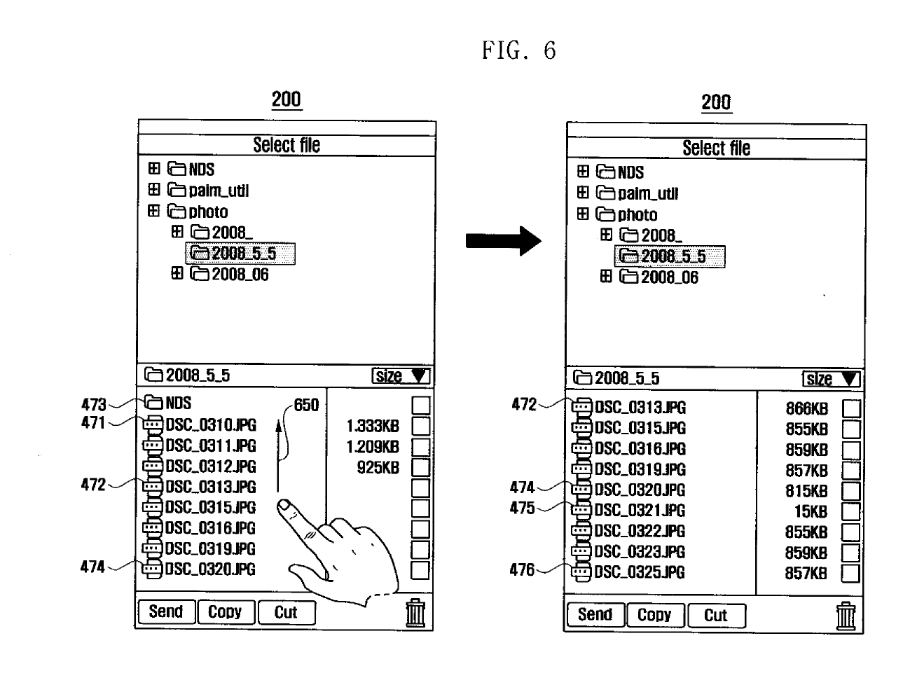

Next, a description is given of functions invoked by touch gestures occurring at touch regions in connection with FIGS. 6 to 8. Here, the touch gesture may correspond to a flick action, drag action or swipe action, which is a touch gesture with a path.

FIG. 6 is screen representations for handling a touch gesture occurring in the first touch region of the visible area.

When a touch gesture 650 occurs at the first touch region 210, list items may be scrolled. Using at least one of the speed and the contact duration of the touch gesture 650, the control unit 150 may scroll items in a preset direction. That is, in response to occurrence of a touch gesture 650 at the first touch region 210, list items may be scrolled. The direction may be determined according to the direction from the touch start point to the touch end point (indicated by arrow). The speed and amount of item shifting may be set by the user or be determined according to at least one of the speed and the contact duration of a touch gesture 650. For example, referring to FIG. 6, before occurrence of a touch gesture 650, items 473 to 474 are displayed in the visible area 200. When the touch gesture 650 occurs in the first touch region 210, items including item 473 and item 471 are caused to disappear, item 472 is positioned at the beginning of the list region 260, and new items 475 to 476 are displayed.

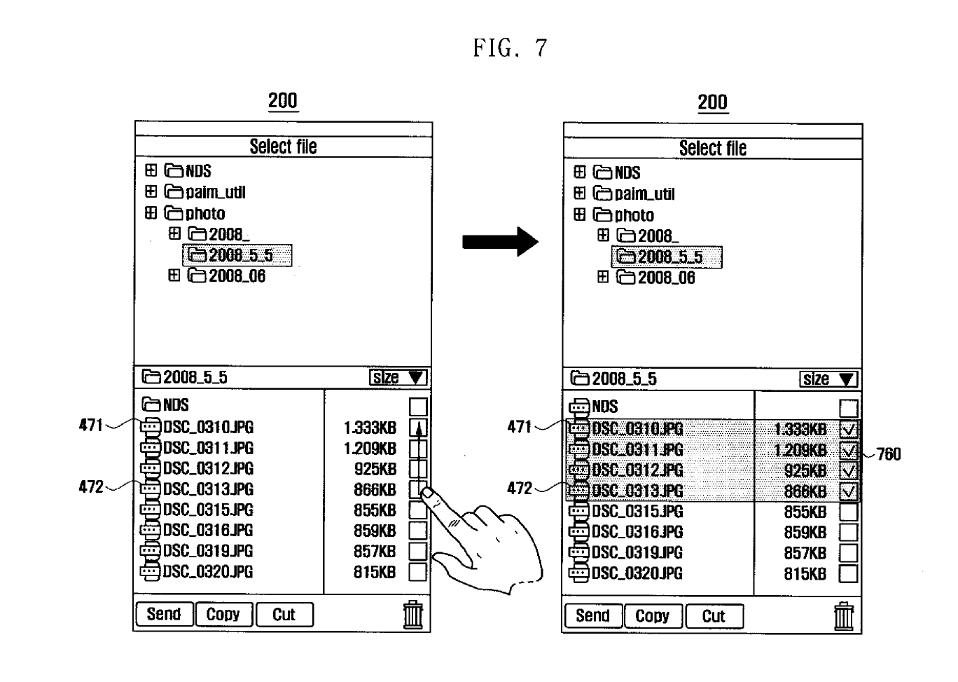

FIG. 7 is screen representations for handling a touch gesture occurring in the second touch region of the visible area.

When a touch gesture 750 occurs at the second touch region 220, the selection status of one or more items on the path from the touch start point to the touch end point may be changed. That is, when a touch gesture 750 occurs in the second touch region 220, the control unit 150 may identify one or more items corresponding to the touch gesture 750. For example, the control unit 150 may identify items 471 to 472 by checking the item zones covered by the path of the touch gesture 750, and change the selection status of items 471 to 472. This is the same for the path of a touch gesture in a reverse direction. The selection status of items 471 to 472 is toggled. That is, for items 471 to 472 that have not been selected before occurrence of the touch gesture 750, a selection mark 760 may be indicated in the check box of the item zone of each of items 471 to 472 after occurrence of the touch gesture 750. Additionally, in response to the touch gesture 750, at least one of the color or brightness of a portion of the item zone associated with each of items 471 to 472 may be changed. In response to reception of a command signal related to a command such as “Send” 371, “Copy” 372, “Cut” 373, and “Delete” 374, the control unit 150 may send information regarding selected items 471 to 472 to the item handling unit 160.

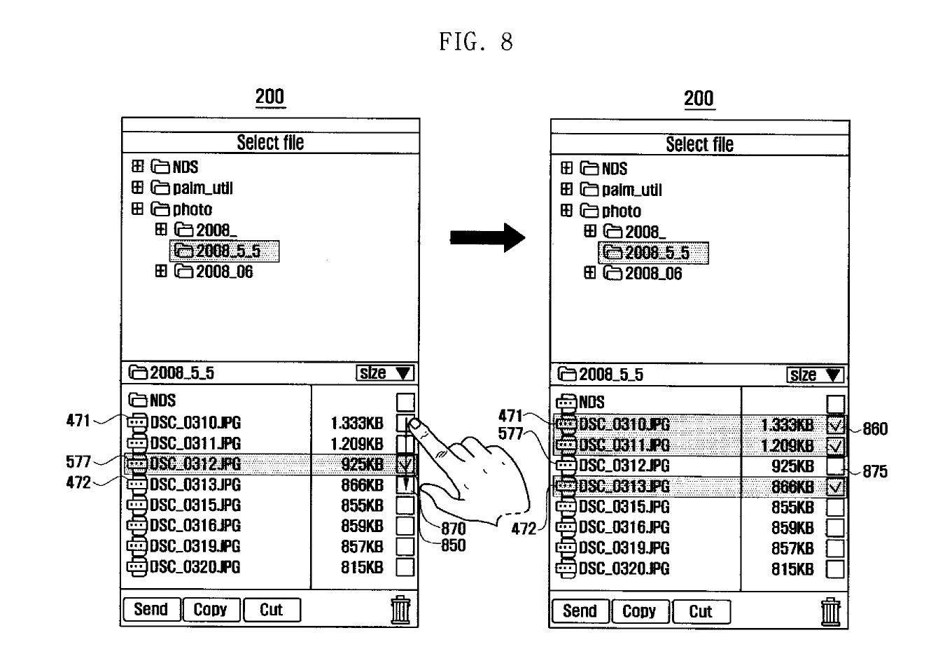

FIG. 8 is screen representations for handling a touch gesture occurring in the second touch region of the visible area.

When a touch gesture 850 occurs at the second touch region 220, the selection status of one or more items on the path from the touch start point to the touch end point may be changed. For example, when the touch gesture 850 occurs after a selection mark 870 is indicated for item 577, the control unit 150 may identify items 471 to 472 by checking the item zones covered by the path of the touch gesture 850, and change the selection status of items 471 to 472. The selection status of items 471 to 472 is toggled. That is, for items 471 to 472 that have not been selected before occurrence of the touch gesture 850, a selection mark 860 may be indicated in the check box of the item zone of each of items 471 to 472 after occurrence of the touch gesture 850. For item 577 that has been selected before occurrence of the touch gesture 850, a selection mark is removed from the check box 875 of item 577 after occurrence of the touch gesture 850. Additionally, in response to the touch gesture 850, at least one of the color or brightness of a portion of the item zone associated with each of items 471 to 472 may be changed. The control unit 150 may send information regarding selected items 471 to 472 (excluding item 577) to the item handling unit 160.

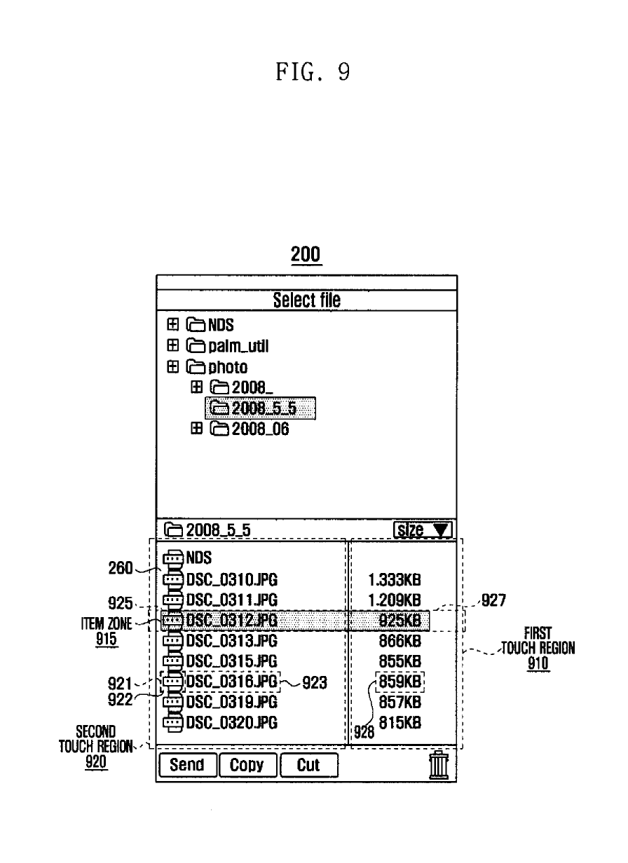

FIG. 9 is another screen representation describing the visible area.

Referring to FIG. 9, the list region 260 may include a first touch region 910 for receiving a touch input to scroll list items, and a second touch region 920 for receiving a touch input to change selection status of each item. In item zone 915, the selection status mark may be unrelated with distinction between the first partial zone 925 and the second partial zone 927. In other words, selection status marks may be indicated independently of distinction between the first touch region 910 and the second touch region 920. For example, in FIG. 3, for each item, the first touch region 210 may include icon 322, name 323 and size 328, and the second touch region 220 may include a check box 317 for selection status indication. In contrast, in FIG. 9, for each item, the first touch region 910 may include size 928, and the second touch region 920 may include icon 922 and name 923. The list region 260 may include at least one item zone 915. Item zone 915 need not include selection status indication such as a radio button or check box. Alternatively, selection status may be indicated by changing the color or brightness of some portion of the item zone 915. A selection status mark such as ‘□’, ‘x’, ‘*’ or ‘o’ may be included at a preset portion of the item zone 915.

The boundary between the first touch region 910 and the second touch region 920 may be drawn using colors, brightness levels and lines. The boundary therebetween may be changed by the user.

The boundary between the first touch region 910 and the second touch region 920 may be hidden from view. That is, the user interface providing apparatus 100 clearly distinguishes the first touch region 910 from the second touch region 920 on the visible area 200 but does not clearly indicate the boundary therebetween. The user may recognize the boundary from experience.

For an item, the first partial zone 325 and the second partial zone 327 may be changed in size according to corresponding item information. Information on an item may include at least one of icon 922, name 923, size 928, modification date, file type and selection status indication.

For example, for an item, the second partial information 921 may include icon 922 and name 923, and the first partial information 928 may include size 928. On the visible area 200, the first partial information 928 may be set in the first partial zone 928 forming the first touch region 910, and the second partial information 921 may be set in the second partial zone 921 forming the second touch region 920. That is, in the item zone 915, the size of the second partial zone 925 forming the second touch region 920 may vary according to item information. In the user interface providing apparatus 100, when the second partial information 921 is set to include icon 922 and name 923 of the associated item, the second touch region 920 may have an irregular boundary. When the size of the first partial zone 928 forming the first touch region 910 is determined by the number of characters in or the space allocated to the size 928, the first touch region 910 may also have an irregular boundary.

In addition, for a touch gesture occurring at the outside of the first partial zone 928 and the second partial zone 921, the control unit 150 may perform a function different from that assigned to the first partial zone 928 or the second partial zone 921, or may ignore the touch gesture. When the first partial zone 928 or the second partial zone 921 is formed as an irregular zone, a separate region other than the first partial zone 928 or the second partial zone 921 may be present. In this case, for a touch gesture occurring at the separate region, a response may result that is different from that of the first touch region 910 or the second touch region 920. That is, a different function may be assigned to the separate region. Alternatively, a touch gesture occurring at the separate region may be ignored.

As described above, the first touch region or the second touch region may be divided into irregular component zones, thereby creating a separate region. A different function may be assigned to the separate region. In addition to functions assigned to the predefined regions, the user may invoke another function by entering a touch input of the same type to the separate region. Hence, it is possible to increase the user's convenience.

In the user interface providing apparatus 100, arrangement of touch regions, display of item information in each touch region, and selection status indication may be modified and implemented in various ways on the basis of descriptions provided in connection with FIGS. 2, 3 and 9.

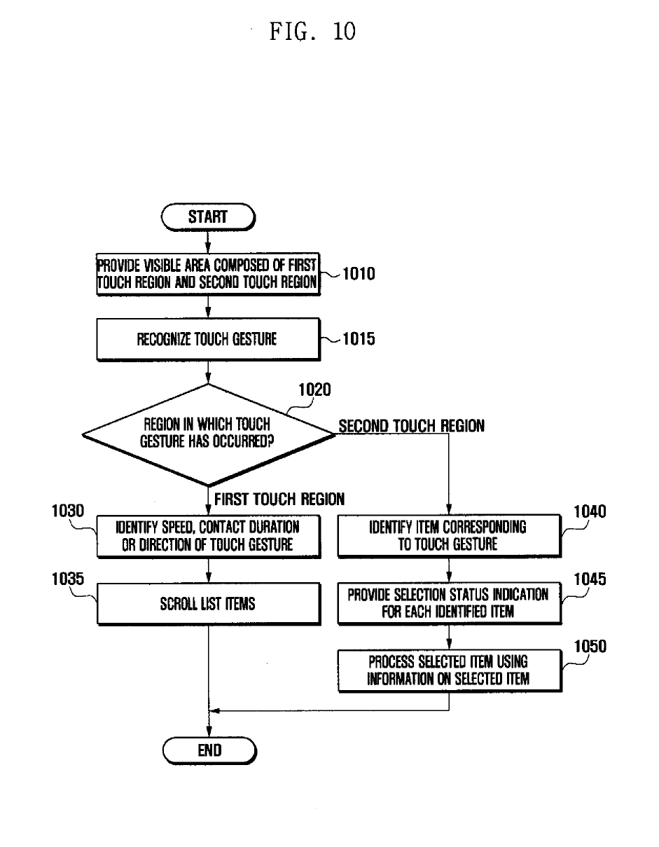

FIG. 10 is a flowchart of a user interface providing method according to another exemplary embodiment of the present invention.

Referring to FIG. 10, the user interface providing apparatus 100 provides a visible area composed of a first touch region and a second touch region (1010). When the first touch region or the second touch region has an irregular form owing to partial zones for item information, the control unit 150 may identify the first partial information and second partial information for each item in advance to thereby recognize the first touch region and the second touch region. The visible area may further include a folder region in which the hierarchical structure of the folder containing items is displayed. The folder region may appear in the visible area in response to reception of an “Attach” command or “Search” command. The first touch region may be used to receive a touch gesture for shifting (or scrolling) items. The second touch region may be used to receive a touch gesture for changing selection status of an item. Thereafter, the user interface providing apparatus 100 receives a touch input signal and recognizes a touch gesture (1015). The user interface providing apparatus 100 may also obtain information regarding the speed, contact duration, and direction of the touch gesture from the touch input signal.

The user interface providing apparatus 100 determines the region in which the touch gesture has occurred (1020). The user interface providing apparatus 100 may also identify the type of the touch gesture. The touch gesture may correspond to a tap, flick, drag or swipe. When the touch gesture has occurred in the first touch region, the user interface providing apparatus 100 identifies at least one of the speed, contact duration and direction of the touch gesture (1030). Using the identified information on the touch gesture, the user interface providing apparatus 100 determines the amount, direction or speed of item shifting on the visible area. The user interface providing apparatus 100 shifts items in the visible area according to the determined amount, direction or speed of shifting (1035). Item shifting in the visible area has been described before in connection with FIGS. 4 and 6.

When the touch gesture has occurred in the second touch region, the user interface providing apparatus 100 identifies at least one item corresponding to the touch point (1040). The user interface providing apparatus 100 may identify one or more items corresponding to the path from the touch start point to the touch end point. The user interface providing apparatus 100 provides the selection status indication for each identified item (1045). Changing selection status for one or more items has been described before in connection with FIGS. 5, 7 and 8. When a command such as “Send”, “Delete”, “Copy” or “Cut-and-paste” is entered, the user interface providing apparatus 100 processes the selected item among the identified items using information on the selected item (1050).

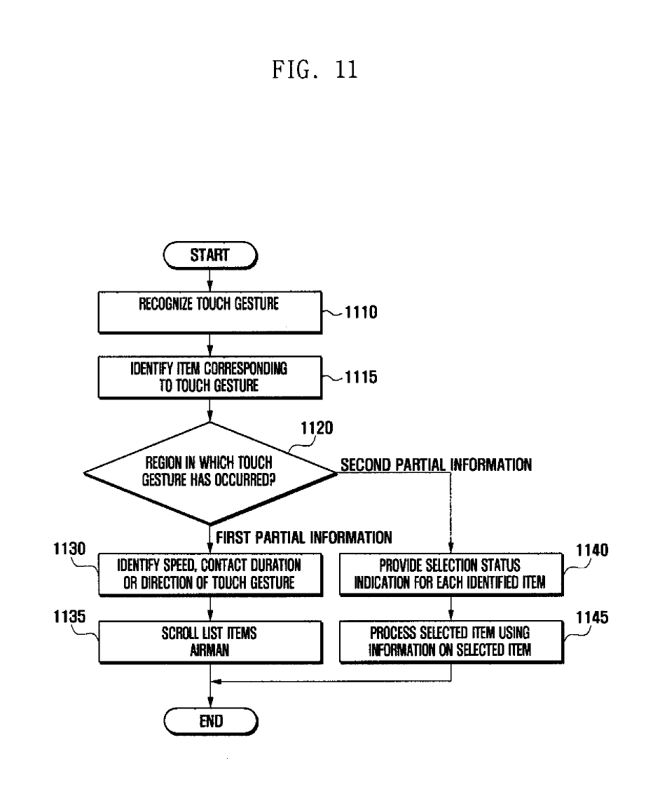

FIG. 11 is a flowchart of a user interface providing method according to another exemplary embodiment of the present invention.

Referring to FIG. 11, the user interface providing apparatus 100 recognizes a touch gesture in the visible area of the touchscreen (1110). The user interface providing apparatus 100 identifies an item corresponding to the touch gesture (1115). The user interface providing apparatus 100 determines whether the touch gesture has occurred on the first partial information of the identified item or on the second partial information thereof (1120).

When the touch gesture has occurred on the first partial information of the identified item, the user interface providing apparatus 100 may perform a first function. Specifically, when the touch gesture has occurred on the first partial information of the identified item, the user interface providing apparatus 100 identifies at least one of the speed, contact duration and direction of the touch gesture (1130) and shifts items using the identified information (1135). Steps 1130 and 1135 correspond respectively to steps 1030 and 1035 of FIG. 10, and a description thereof will thus be omitted. When the touch gesture has occurred on the second partial information of the identified item, the user interface providing apparatus 100 may perform a second function. Specifically, when the touch gesture has occurred on the second partial information of the identified item, the user interface providing apparatus 100 provides selection status indication for the identified item (1140) and processes the selected item using information on the selected item (1145). Steps 1140 and 1145 correspond respectively to steps 1045 and 1050 of FIG. 10, and a description thereof will thus be omitted.

Note that the above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

What is claimed is:

1. A method for providing a user interface, comprising:
providing a visible area composed of a first touch region for displaying list items according to a hierarchical order and a second touch region for indicating selection status of each item;
determining whether a touch gesture has occurred in the first touch region or in the second touch region; and
shifting the items in the visible area responsive to the touch gesture in the first touch region, and changing the selection status of an item responsive to the touch gesture in the second touch region.

2. The method of claim 1, wherein changing selection status of an item comprises displaying selection status of each item covering from a touch start point to a touch end point of the touch gesture as marked.

3. The method of claim 1, wherein changing selection status of an item comprises displaying selection status of each item covering from a touch start point to a touch end point of the touch gesture, except an item previously checked, as marked.

4. The method of claim 1, wherein determining whether the touch gesture has occurred comprises determining the type of the touch gesture.

5. The method of claim 4, wherein the touch gesture corresponds to one of a tap, flick, drag and swipe.

6. The method of claim 1, wherein changing selection status of an item comprises identifying at least one item corresponding to a touch point.

7. The method of claim 6, wherein changing selection status of an item further comprises displaying selection status of each identified item at a portion of the second touch region.

8. The method of claim 7, wherein displaying selection status of each identified item comprises toggling a status mark in a radio button or check box corresponding to each identified item.

9. The method of claim 6, wherein changing selection status of an item comprises changing at least one of the color and brightness of a zone corresponding to each identified item in the first touch region.

10. The method of claim 1, wherein shifting the items in the visible area comprises shifting items in the visible area in a preset direction according to at least one of speed, contact duration, and direction of the touch gesture.

11. An apparatus for providing a user interface, comprising:
a display handler providing a visible area composed of a first touch region for displaying list items according to a hierarchical order and a second touch region for indicating selection status of each item;
a touch recognizer detecting occurrence of a touch gesture in the visible area; and
a control unit determining whether the touch gesture has occurred in the first touch region or in the second touch region, and shifting, when the touch gesture has occurred in the first touch region, the items in the visible area, and changing, when the touch gesture has occurred in the second touch region, selection status of an item.

12. The method of claim 11, wherein changing selection status of an item comprises displaying selection status of each item covering from a touch start point to a touch end point of the touch gesture as marked.

13. The method of claim 11, wherein changing selection status of an item comprises displaying selection status of each item covering from a touch start point to a touch end point of the touch gesture, except an item previously checked, as marked.

14. The apparatus of claim 11, wherein the control unit determines the type of the touch gesture.

15. The apparatus of claim 11, wherein the control unit identifies, when the touch gesture has occurred in the second touch region, at least one item corresponding to the touch point.

16. The apparatus of claim 15, wherein the control unit controls an operation to display selection status of each identified item at a portion of the second touch region.

17. The apparatus of claim 16, wherein the control unit controls an operation to toggle a status mark in a radio button or check box corresponding to each identified item.

18. The apparatus of claim 15, wherein the control unit controls, when the touch gesture has occurred in the second touch region, an operation to change at least one of the color and brightness of a zone corresponding to each identified item in the first touch region.

19. The apparatus of claim 11, wherein the control unit controls, when the touch gesture has occurred in the first touch region, an operation to shift items on the visible area in a preset direction according to at least one of speed, contact duration, and direction of the touch gesture.

20. The apparatus of claim 11, wherein the control unit controls, when the touch gesture has occurred in the second touch region, an operation to display selection status of each item corresponding to the path from the touch start point to the touch end point at a portion of the second touch region.
